(19) United States
(12) Patent Application Publication
(10) Pub. No.: US 2019/0323282 A1
(43) Pub. Date: Oct. 24, 2019

(54) STRUT FOR WINDLOAD DOOR

(71) Applicant: Assa Abloy Entrance Systems AB, Landskrona (SE)

(72) Inventor: Mark Sowinski, Lawrence, KS (US)

(21) Appl. No.: 15/956,488

(22) Filed: Apr. 18, 2018

(51) Int. Cl. E06B 3/48; E05D 15/24

(52) U.S. Cl. CPC E06B 3/488; E06B 3/486; E05D 15/22; E05Y 2900/106; E05D 15/242

(57) ABSTRACT

Disclosed is strut for a wind load door comprised of connected portions disposed at angles to one another. The strut comprises a mounting portion, the mounting portion including a fastener mechanism adapted to connect the strut to a panel of the door. The mounting portion is connected with a first oblique portion, a first edge of the first oblique portion connected with the mounting portion at a first edge of the mounting portion, the first oblique portion extending at a first angle with respect to the mounting portion. The mounting portion is connected with a leg portion, a first edge of the leg portion connected with the mounting portion at a second edge of the mounting portion, the leg portion extending at a second angle with respect to the mounting portion. The leg portion is connected with a web portion, a first edge of the web portion connected with a second edge of the leg portion, the web portion extending at a third angle from the leg portion. The web portion is connected with a second oblique portion, a first edge of the second oblique portion connected with a second edge of the web portion, the second oblique portion extending at a fourth angle from the web portion. The strut may include one or more ribs extending along a portion of the mounting portion and the leg portion.

### BACKGROUND

### Field

The present disclosure relates to reinforcing struts for door panels and more particularly, to struts for garage doors designed to withstand high wind loads.

### Description of the Related Art

Doors for garages, loading bays, warehouses and other structures that accommodate the passage of vehicles and people generally have a large exposed surface area. Such doors are subject to significant forces during high wind events. When these forces exceed the strength of the door, the door may fail, allowing wind and rain to enter the garage and attached structures. This can lead to water damage and to structural damage because of overpressure. Building codes in regions where high wind conditions are more common, for example, the Southeastern United States, typically require that garage doors be certified to meet or exceed a specified wind load. Insurers may also require that large area doors meet wind load requirements in order to insure a structure against wind damage.

Typically, garage doors are formed from a series of panels connected to one another by hinges. These panels may be formed from rolled or stamped sheets of metal creating so-called “pans.” Panels may also be formed from an embossed metal skin surrounding a thermally insulating foam core. To make the panels stronger requires using thicker metal components that are generally heavier and more costly.

Instead of strengthening the panels themselves to withstand wind load forces, one or more struts are connected to the panels. These struts may be connected to the inside surface of the panels forming the door and extend horizontally across the width of the panel. The struts are typically made from a steel sheet roll formed into a U-shape so that the legs of the “U” are perpendicular to the inner surface of the door panel. The strut resists bending in response to forces applied normal to the surface of the door by wind and/or differences in air pressure inside and outside the door.

In general, the strength of known struts depends on the length of the legs of the “U” forming the strut, the type of material used to form the strut, and the thickness of the material. To provide sufficient strength against winds encountered in heavy storms, thicker and/or larger struts are used. In addition, to achieve the required strength, additional struts may be added to one or more of the panels forming the door. Using large or thicker struts or adding additional struts increases the material cost and adds complexity to door manufacturing.

Strengthening door panels by adding thick or larger struts may also increase the weight of the door, making the door more difficult or more expensive to operate. Typically, to assist a user in manually lifting a garage door, one or more counter balance springs are provided to bias the door in the upward direction. Heavier doors may require springs capable of providing higher forces. Under some circumstances, heavier springs add expense to the door mechanism. In addition, in many cases garage doors are equipped with motorized door opening mechanisms. These devices are activated to open and close by a transmitter in the user's vehicle and/or by a wall switch inside the garage using an electric motor. Heavier doors may require more energy to operate.

Larger struts may also impact the usable space within the garage. Typically, garage doors engage with tracks located on either side of the doorway. Rollers connected with the door panels engage with these tracks to guide the door as it opens and closes. In many garages, the tracks extend vertically along the sides of the doorway and then bend into the horizontal direction so that the door panel is parallel to the ceiling of the garage when the door is open.

When the door is open, struts connected with the inside surface of the door panels extend downward. The distance the struts extend downward from the open garage door may determine the headroom available inside the garage. To achieve sufficient strength to resist windloads may require using taller struts that limit the headroom, preventing larger vehicles, for example, large sport utility vehicles and vehicles with roof racks from fitting in the garage.

Using multiple struts on a door panel to achieve a given strength may not be practical. Garage doors often include windows to admit light into the garage and create an architecturally pleasing arrangement. Windows are located on one or more of the door panels. Generally, it is not desirable to extend a strut across a window because this blocks light and the portion of the strut visible through the window may be unsightly. Thus, at least for door panels with windows, it may be undesirable to add additional struts and instead larger, heavier struts may be required to provide sufficient strength to door panels including a window.

Thus, there is a need for an improved strut for wind load doors such as Sectional garage doors that provides sufficient strength to withstand a given wind load that uses less material, is of lighter weight, and allows greater headroom below the surface of the open door than is provided by known struts.

### SUMMARY

The present disclosure relates to apparatuses and methods to address these and other difficulties.

According to one embodiment there is provided a door strut for a wind load door comprising a mounting portion, the mounting portion including a fastener mechanism adapted to connect the strut to a panel of the door; a first oblique portion, a first edge of the first oblique portion connected with the mounting portion at a first edge of the mounting portion, the first oblique portion extending at a first angle with respect to the mounting portion; a leg portion, a first edge of the leg portion connected with the mounting portion at a second edge of the mounting portion, the leg portion extending at a second angle with respect to the mounting portion; a web portion, a first edge of the web portion connected with a second edge of the leg portion, the web portion extending at a third angle from the leg portion; and a second oblique portion, a first edge of the second oblique portion connected with a second edge of the web portion, the second oblique portion extending at a fourth angle from the web portion.

According to one aspect of the disclosure the web portion is parallel with the mounting portion.

According to another aspect of the disclosure the first angle is between about 45 degrees and about 135 degrees. According to another aspect, the first angle is about 120 degrees.

According to another aspect of the disclosure the second angle and the third angle are about 90 degrees.

According to another aspect of the disclosure the fourth angle is between about 45 degrees and about 135 degrees. According to another aspect the fourth angle is about 120 degrees.

According to another aspect of the disclosure, the strut further comprises one or more ribs, each rib extending along a portion of the mounting portion and the leg portion. According to another aspect the rib is formed by stamping. According to another aspect the rib is attached to surfaces of the strut by a fastener.

According to another aspect of the disclosure the first oblique portion, mounting portion, leg portion, web portion, and second oblique portion are formed from a single sheet of material and wherein the first, second, third, and fourth angles are formed by bending the sheet. According to another aspect, the material is steel.

According to another embodiment of the disclosure there is provided a wind load door comprising, a plurality of door panels, the panels arranged in a door frame to span a doorway; one or more hinges, the hinges connecting adjacent panels; and one or more door struts, each strut connected with a one of the plurality of door panels, the struts comprising a mounting portion, the mounting portion including a fastener mechanism adapted to connect the strut to a panel of the door; a first oblique portion, a first edge of the first oblique portion connected with the mounting portion at a first edge of the mounting portion, the first oblique portion extending at a first angle with respect to the mounting portion; a leg portion, a first edge of the leg portion connected with the mounting portion at a second edge of the mounting portion, the leg portion extending at a second angle with respect to the mounting portion; a web portion, a first edge of the web portion connected with a second edge of the leg portion, the web portion extending at a third angle from the leg portion; and a second oblique portion, a first edge of the second oblique portion connected with a second edge of the web portion, the second oblique portion extending at a fourth angle from the web portion.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an elevation view of the inside of a garage door including struts according to an embodiment of the disclosure;

FIG. 2 is a perspective view of the garage door of FIG. 1 showing the door in a closed position and a phantom image of the door in an open position;

FIGS. 3a, 3b, and 3c are detailed views of portions of the garage door of FIG. 1;

FIG. 4 is a cross section of a strut according to an embodiment of the disclosure;

FIG. 5a is a perspective view of a portion of a strut according to another embodiment of the disclosure;

FIG. 5b is a perspective view of a gusset that is added to a strut according to another embodiment of the disclosure;

FIGS. 6a and 6b show cross sections of a prior art strut and a strut according to another embodiment of the disclosure, respectively;

FIGS. 7a and 7b show cross sections of a prior art strut and a strut according to another embodiment of the disclosure, respectively;

FIGS. 8a and 8b show cross sections of a prior art strut and a strut according to another embodiment of the disclosure, respectively;

FIG. 9 show cross section of a strut according to another embodiment of the disclosure; and

FIG. 10 shows a perspective view of a strut according to another embodiment of the disclosure.

### DETAILED DESCRIPTION

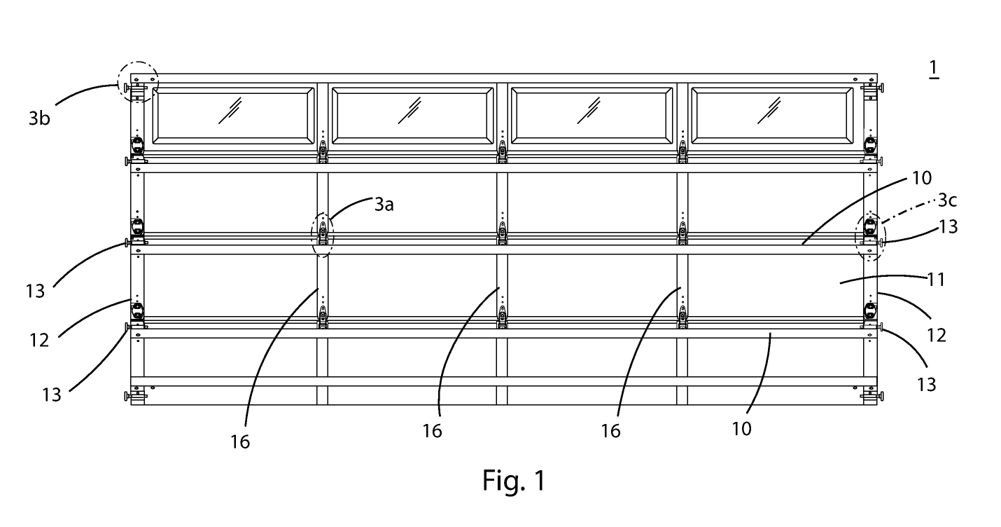

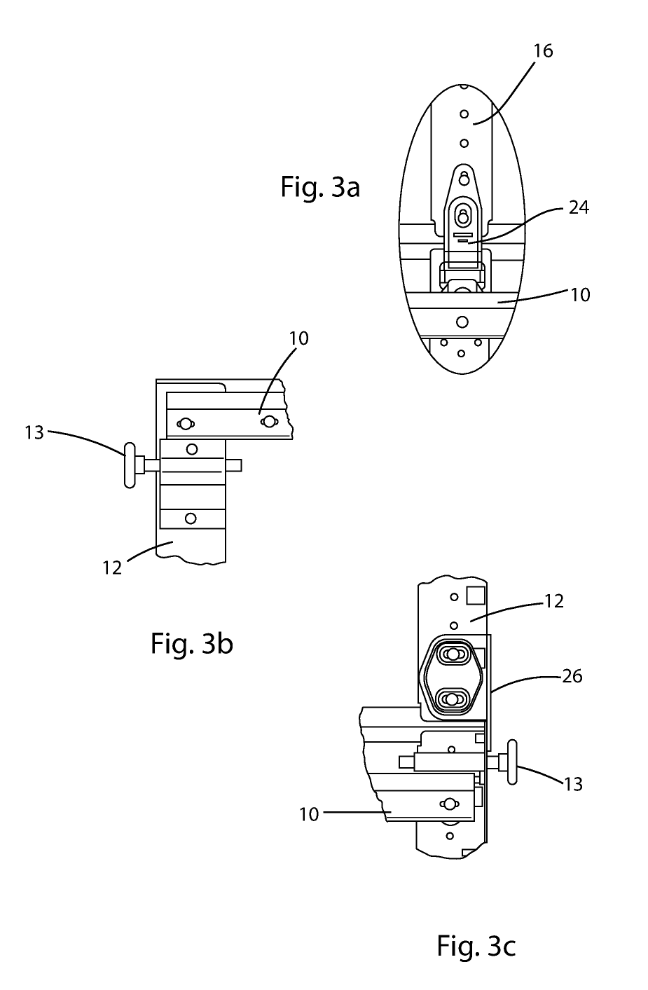

FIG. 1 is an interior view of a garage door 1 designed for high wind load applications according to an embodiment of the disclosure. The door is comprised of a number of panels 11 arranged horizontally. The panels include end stiles 12 and one or more center stiles 16. One or more struts 10 are connected with the panels 11. Rollers 13 are provided the ends of the panels. As shown in detail in FIGS. 3a-3c, panels 11 are connected to one another by hinges 24, 26 affixed to the center stiles 16 and end stiles 12 of adjacent panels 11. Backer plates (not shown) may be provide within end and center stiles to provide a secure connection between panels 11 and the hinges and struts. Alternatively, or in addition to backer plates within the panel 11, external mounting brackets may be provided on the outer surface of the panel 11.

Each panel 11 may be formed as a single sheet of metal rolled or stamped to form a so-called pan. Alternatively, panel 11 is formed from an embossed steel skin surrounding a hollow center. The hollow center may be filled with a thermal and/or sound insulating material, such as a polymer foam. Some panels may include windows 14.

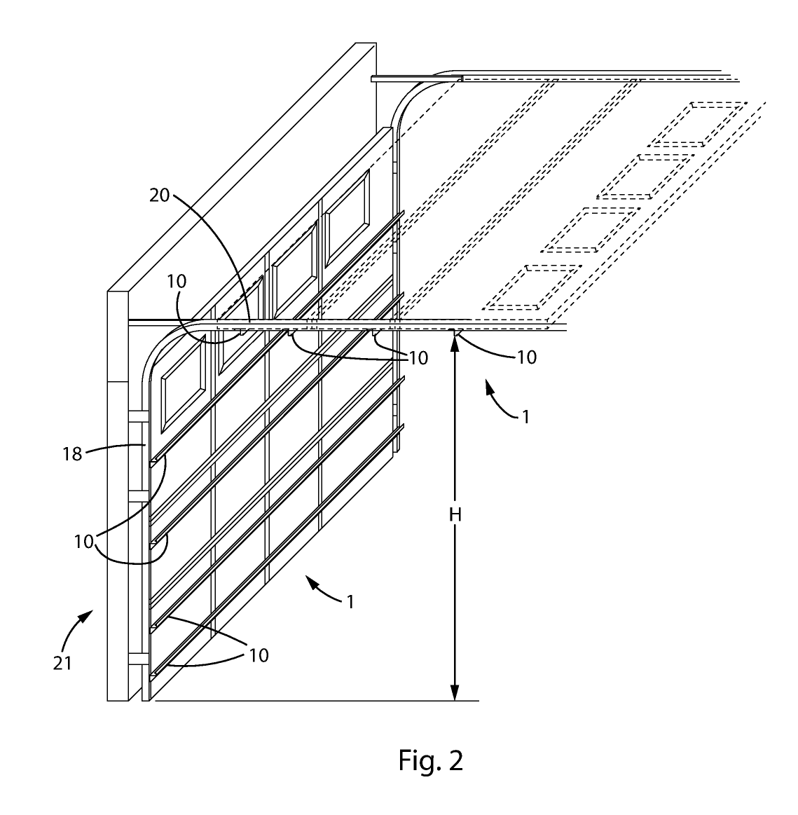

As shown in FIG. 2, door 1 is positioned in a doorway 21. Rollers 13 engage with tracks 18 along the sides of the doorway. According to one embodiment, the portions of tracks 18 above the doorway bend inward creating a horizontal portion 20. When the door is raised along the tracks to open the doorway, door 1 is supported by horizontal portions 20. When the door is open, struts 10 extend downward from the inner surface of door 1, as shown in the phantom image in FIG. 2. A clearance height, H, is provided between the floor of the garage and the bottom of the struts 10. Providing struts 10 that extend less far from the surface of the panel increases the headroom, allowing taller vehicles to fit in the garage.

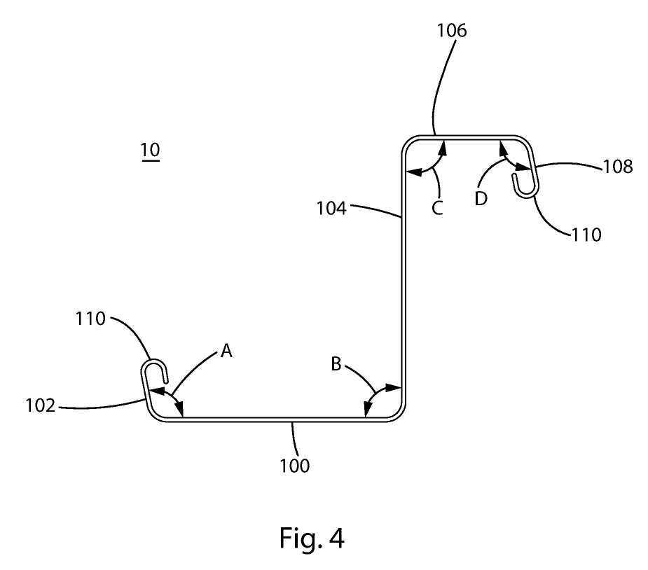

FIG. 4 shows cross section of a strut 10 according to an embodiment of the disclosure. Strut 10 may be formed from a sheet of metal that is shaped by bending, forging, stamping, rolling, or like processes to create an elongated body with the disclosed cross section. Alternatively, strut 10 can be molded or extruded from a material that can be shaped by a mold cavity or extrusion die.

According to one embodiment, strut 10 is formed by stamping from a rolled steel sheet. According to a preferred embodiment, the sheet is Commercial Steel type B with a thickness of 0.034″ (20 gauge) with a minimum yield strength of from about 30 ksi to about 80 ksi. According to a most preferred embodiment, the sheet has a minimum yield strength of 80 ksi.

Strut 10 has a mounting portion 100. When the strut is installed on panel 11, mounting portion 100 contacts the end stiles 12 and center stiles 16 of the panel. According to one embodiment, holes are provided through mounting portion 100 at locations corresponding to the end and center stiles of the panel. Fasteners, for example, screws or bolts, are inserted through the holes in the mounting portion 100 and into threaded holes in the stiles. According to another embodiment, the mounting portions 100 of struts 10 are welded to end and center stiles of the panel.

Along one edge of mounting portion 100 is first oblique portion 102. The plane of first oblique portion 102 is at an angle, A, with respect to mounting portion 100. According to one embodiment, angle A is between about 45° and 135°. According to a preferred embodiment, angle A is 120°. A crimp 110 may be formed along the free edge of first oblique portion.

Along the edge of mounting portion 100 opposite first oblique portion 102 is leg portion 104. The plane of leg 104 forms angle, B, with mounting portion 100. According to a preferred embodiment, angle B is about 90°.

Along the edge of leg 104 opposite mounting portion 100 is web portion 106. The plane of web portion 106 forms angle, C, with leg 104. According to a preferred embodiment, angles B and C are each 90° and web portion 106 is parallel with mounting portion 100.

Along the edge of web portion 106 opposite leg portion 104 is second oblique portion 108. The plane of second oblique portion 108 forms an angle D with web portion 106. According to one embodiment, angle D is between 45° and 135°. According to a preferred embodiment, angle D is 120°. A crimp or hem 110 may be formed along the free edge of second oblique portion 108.

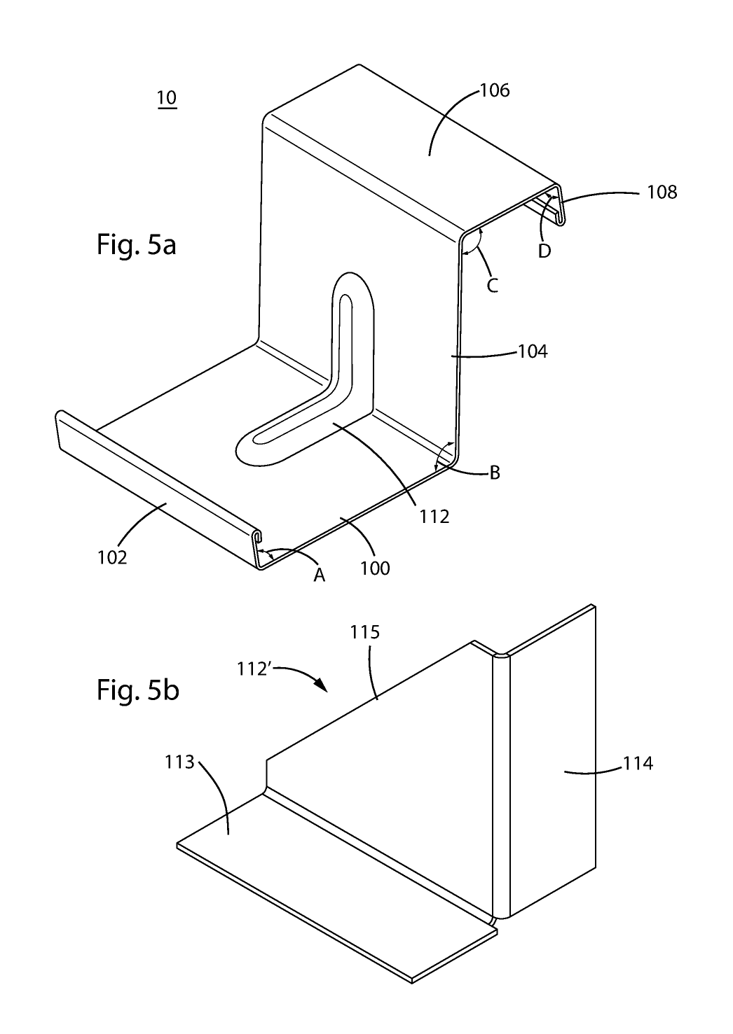

FIG. 5a is a perspective view of another embodiment of the disclosure. Similar features of this embodiment are designated with the same numbers are in the previous embodiments. Strut 10 is composed of mounting portion 100, first oblique portion 102, leg portion 104, web portion 106, and second oblique potion 108, as in the previous embodiments. In this embodiment, rib 112 spans parts of mounting portion 100 and leg portion 104. Rib 112 may be formed by stamping the sheet of material forming strut 10 to create a convex region as shown in the figure.

Alternatively, rib 112 or a gusset 112′ can be a separate component connected with the surfaces of mounting portion 100 and leg portion 104 by fasteners, by welding, or by other connecting techniques known in the art. FIG. 5b shows a gusset 112′ formed as a separate part that is joined with strut 10. Gusset 112′ comprises mounting portions 113 and 114 adapted to be joined with the mounting portion 100 and leg portion 104 of strut 10, by fasteners, welding, adhesives, or other joining methods known in the art. Support portion 115 connects mounting portions 113, 114.

Multiple ribs 112 or gussets 112′ are provided along the length of strut 10. According to one embodiment, ribs 112 or gussets 112′ are provided at regular intervals along the length of strut 10. For example, the interval may be every foot, every two feet, or every three feet along the length of strut 10.

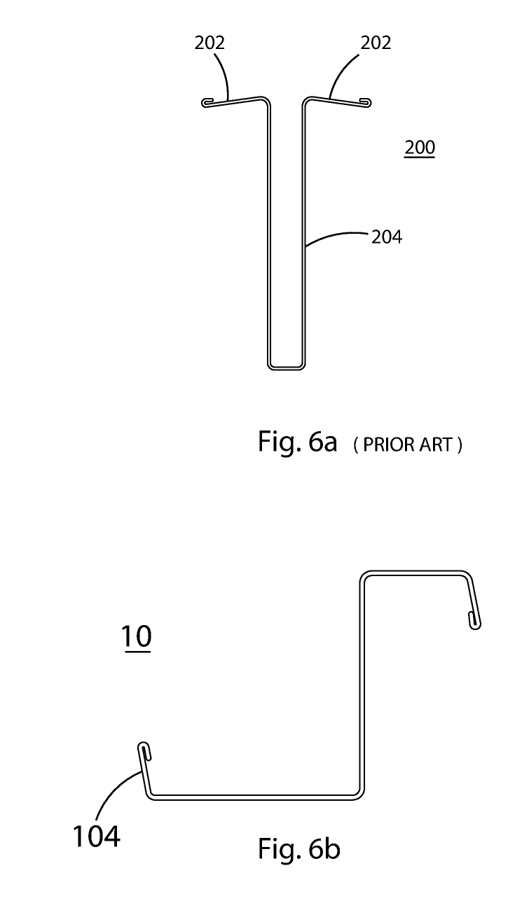

FIG. 6a shows a prior art strut 200 for a wind load door. Strut 200 has legs 204 that extend from mounting portions 202 and form a U-shaped structure. In this example, legs 204 are 3 inches long. Thus, when installed on a door panel, strut 200 extends at least 3 inches from the surface of the panel. The cross-sectional area of strut 200 is approximately 0.28 sq. in.

FIG. 6b shows strut 10 according to an embodiment of the disclosure. Strut 10 is designed for similar applications as the one shown FIG. 6a. The length of leg portion 104 is 2.25 inches, that is, 0.75 inches less than that of leg 204 of the prior art strut. Thus, when strut 10 is installed on a door panel, the clearance height, H, as shown in FIG. 2 is greater than when strut 200 is used. The cross-sectional area of strut 10 is approximately 0.22 sq. in., which is approximately 21% less than the area of the prior art strut meaning there is 21% less material required to form strut 10 as compared with prior art strut 200.

Despite being shorter and requiring less material to form that the prior art strut, strut 10 according to the present disclosure is stronger. Sixteen-foot long struts with cross sections shown in FIGS. 6a and 6b were each formed from SS Grade 80 Commercial Steel type B with a minimum yield strength of 80 ksi, and a thickness of 0.034″ (20 gauge). Each was attached along the centerline of a respective 16-foot garage door panel. To compare the strength of the struts, each panel including its respective strut was placed with its ends resting on saw horses so that middle portion of the panel was unsupported. Weights were place on the panel until the panel buckled. The distribution of weights along the length of the panels was the same for both struts. The panel including the prior art strut shown in FIG. 6a failed when the panel was subject to a load of 421 pounds, including the weight of the panel itself. The panel including the strut shown in FIG. 6b failed when it was subject to a load of 539.5 pounds, again including the weight of the panel. Thus, strut 10 was able to support 28% more weight than the larger prior art strut.

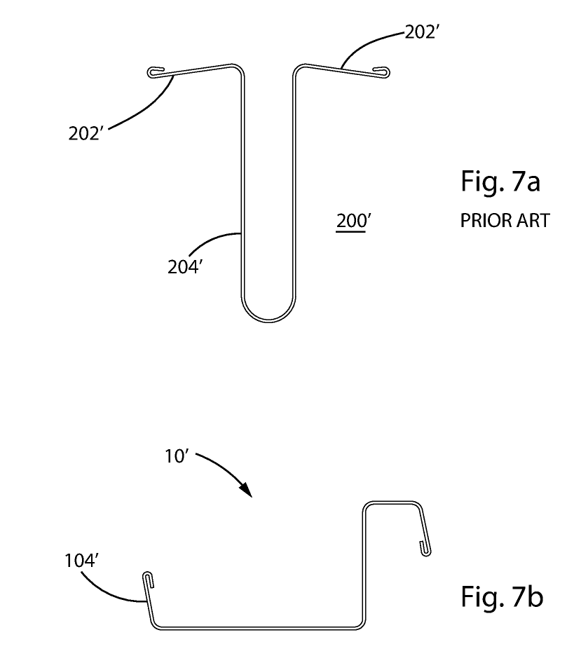

FIG. 7a shows another prior art strut 200′ for a wind load door with mounting portions 202′ and legs 204′ forming a U-shaped structure. In this example, legs 204′ are 2 inches long. The cross-sectional area of strut 200′ is approximately 0.21 sq. in.

FIG. 7b shows strut 10′ according to an embodiment of the disclosure designed for similar applications as strut 200′ shown FIG. 7a. The length of leg portion 104′ is 1.25 inches, that is, 0.75 inches less than that of leg 204′ of the prior art strut. The cross-sectional area of strut 10′ is approximately 0.18 sq. in., which is approximately 14% less than the area of the prior art strut meaning there is 14% less material required to form strut 10′ as compared with the prior art strut.

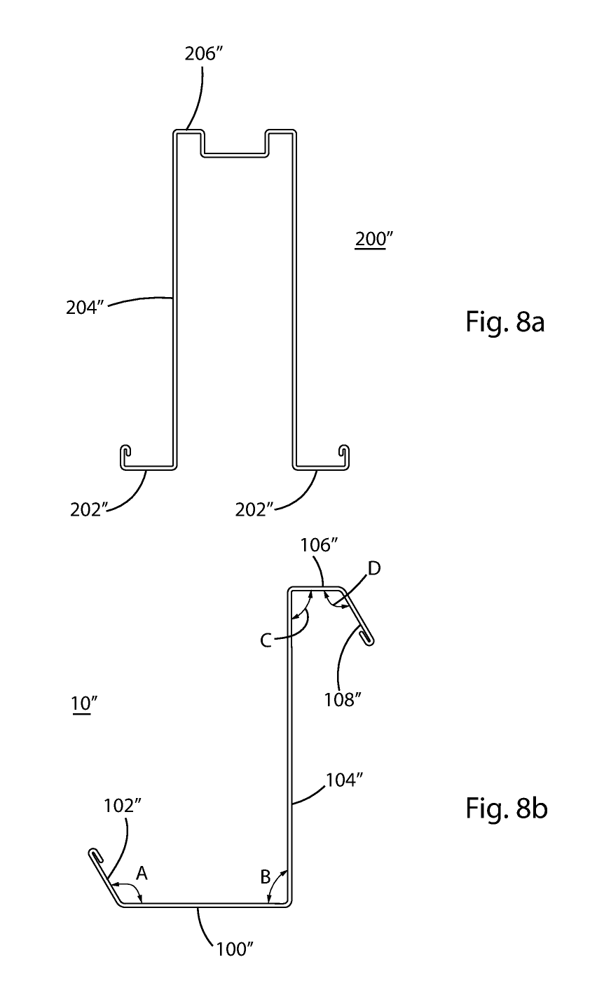

FIG. 8a shows another prior art strut 200″ for a wind load door. Strut 200″ is also referred to as an R truss. Legs 204″ extend from the mounting portions 202″. Strut 200″ includes a stepped portion 206″ connecting leg portions 204″. As with the prior art struts shown in FIGS. 6a and 7a, mounting portions 202″ are provided to mount the strut to a panel. In this example, legs 204″ are 5.5 inches long. The cross-sectional area of strut 200″ is approximately 0.78 sq. in.

FIG. 8b shows strut 10″ according to an embodiment of the disclosure designed for similar applications as the one shown FIG. 8a. In this embodiment, the plane of first oblique portion 102″ is at angle A with respect to mounting portion 100″ and the plane of second oblique portion 106″ is at an angle D with respect to web portion 106″. In this embodiment the angles A and D are approximately 120°, that is, approximately 30° from vertical. The length of leg portion 104″ is 5.5 inches, that is, same height of the prior art strut. The cross-sectional area of strut 10 is approximately 0.57 sq. in., which is approximately 26% less than the area of the prior art strut meaning there is 26% less material required to form strut 10″ as compared with the prior art strut.

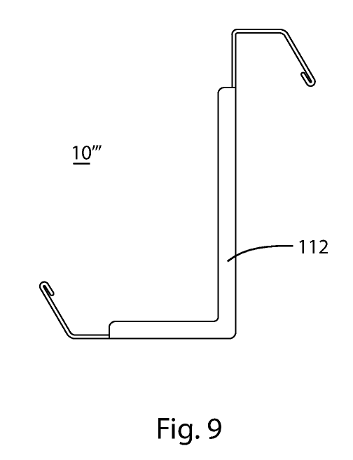

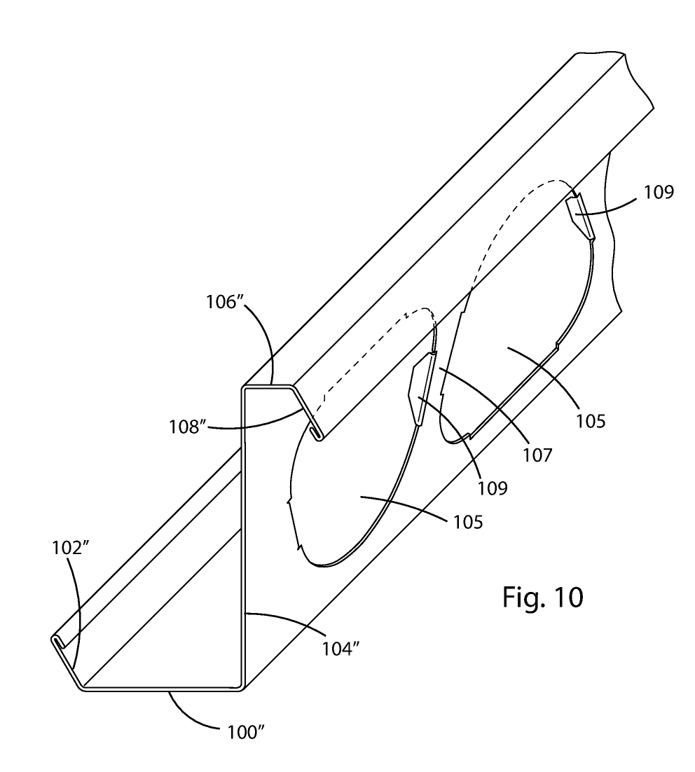

FIG. 9 shows a further embodiment of the disclosure also for similar applications as the one shown FIG. 8a. The dimensions of strut 10′″ are the same as those of strut 10″. Strut 10′″ includes rib 112, such as the rib discussed with regard to FIG. 5. Rib 112 is stamped into the sheet of metal forming the strut. Thus, the rib does not add any material to the strut and the amount of material is the same as that forming strut 10″ shown in FIG. 8b. That is, the area dimension in FIG. 10 does not reflect the actual amount of material needed to form the strut. Thus, strut 10′″ is formed from the same amount of material as strut 10″ and used approximately 26% less material than the prior art R truss shown in FIG. 8a. Again, the height of strut 10′″ is the same as that of the R truss, resulting in no loss of headroom, H as shown in FIG. 2, in a garage equipped with the disclosed embodiment compared with the prior art strut.

FIG. 10 shows a further embodiment of the disclosure with a cross section like that shown in FIG. 8b. Strut 10″ is formed with a mounting portion 100″, a first oblique portion 102″, a leg portion 104″, a web portion 106″ and a second oblique portion 108″ as in the embodiment shown in FIG. 8b. In this embodiment, cut-outs 105 are provided through leg portion 104″. Cut-outs 105 may be provided at regular intervals along strut 10″. According to a further embodiment, cut-outs 105 are formed in pairs, with a portion of adjacent cut-outs overlapping as viewed along the height of leg portion 104″ to form one or more angled beams 107. The thickness and shape of beams 107 and the size, shape and number of cut-outs 105 are selected to provide sufficient strength to leg portion 102, while reducing the weight of strut 10. According to a further embodiment, cut-outs 105 include tabs 109 connected with the edges of beams 107. Tabs 109 are bent to form an angle of about 90° with the surface of leg portion 104″. Where tabs 109 are formed on either edge of beam 107, the tabs and beam create a c-shaped cross section, thereby improving the resistance of beam 107 to deflection.

Cut-outs 105 may be formed by a stamping die to create holes in the sheet of material that forms strut 10. Alternatively, such holes may be created by cutting, burning, forging, or other process known in the art. The sheet, including the holes, is then formed into the Z-shaped cross section shown, for example, in FIG. 8b. Tabs 109 are then bent to be perpendicular with the surface of leg portion 102 to create a c-shaped cross section for beams 107.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

1. A door strut for a wind load door comprising:
a mounting portion, the mounting portion adapted to connect the strut to a panel of the door;
a first oblique portion, a first edge of the first oblique portion connected with the mounting portion at a first edge of the mounting portion, the first oblique portion extending at a first angle with respect to the mounting portion;
a leg portion, a first edge of the leg portion connected with the mounting portion at a second edge of the mounting portion, the leg portion extending at a second angle with respect to the mounting portion;
a web portion, a first edge of the web portion connected with a second edge of the leg portion, the web portion extending at a third angle from the leg portion; and
a second oblique portion, a first edge of the second oblique portion connected with a second edge of the web portion, the second oblique portion extending at a fourth angle from the web portion.

2. The door strut of claim 1, wherein the web portion is parallel with the mounting portion.

3. The door strut of claim 1, wherein the first angle is between about 45 degrees and about 135 degrees.

4. The door strut of claim 3, wherein the first angle is about 120 degrees.

5. The door strut of claim 1, wherein the second angle and the third angle are about 90 degrees.

6. The door strut of claim 1, wherein the fourth angle is between about 45 degrees and about 135 degrees.

7. The door strut of claim 6, wherein the fourth angle is about 120 degrees.

8. The door strut of claim 1, further comprising one or more ribs or gussets, each rib or gusset extending along a portion of the mounting portion and the leg portion.

9. The door strut of claim 8, wherein the rib is formed by stamping.

10. The door strut of claim 8, wherein the rib or gusset is attached to surfaces of the strut by a fastener, by welding, or by an adhesive.

11. The door strut of claim 1, wherein the first oblique portion, mounting portion, leg portion, web portion, and second oblique portion are formed from a single sheet of material and wherein the first, second, third, and fourth angles are formed by bending the sheet.

12. The door strut of claim 11, wherein the material is steel.

13. The door strut of claim 1, wherein the leg portion comprises one or more cut-outs.

14. The door strut of claim 13, wherein the cut-outs include one or more tabs, the tabs set at an angle to the surface of the leg portion.

15. The door strut of claim 14, comprising a plurality of cut-outs, the cutouts arranged in pairs, wherein adjacent cut-outs overlap one another along the height of the leg portion forming an angled beam and wherein tabs on the adjacent cut-outs form a c-shaped cross section with the beam.

16. A wind load door comprising:
a plurality of door panels, the panels arranged in a door frame to span a doorway;
one or more hinges, the hinges connecting adjacent panels; and
one or more door struts of claim 1, each strut connected with a one of the plurality of door panels.
